(19) United States
(12) Patent Application Publication
(10) Pub. No.: US 2025/0363117 A1
(43) Pub. Date: Nov. 27, 2025

(54) SYSTEMS AND METHODS FOR CATEGORIZING AND MANAGING PERSONAL DATA STORAGE USING ARTIFICIAL INTELLIGENCE (AI) AGENTS

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,290

(22) Filed: May 22, 2025

(30) Foreign Application Priority Data
May 22, 2024 (IN) 202311079241

(51) Int. Cl. G06F 16/2457; G06F 16/27; G06F 16/28; G06F 21/62

(52) U.S. Cl. CPC G06F 16/2457; G06F 16/27; G06F 16/285; G06F 21/6218

(57) ABSTRACT

System and method for managing interaction of data between Artificial Intelligent (AI) agents within a secure cloud-based enclave are disclosed. The method comprises initiating, by a single AI agent, an interaction request with a shared AI agent. The shared AI agent triggers a negotiation and authorization process to the single AI agent based on the interaction request. The negotiation and authorization process determines whether the single AI agent is eligible to interact with the shared AI agent. The shared AI agent receives user data from the single AI agent when the single AI agent is eligible to interact with the shared AI agent. The shared AI agent categorizes the user data into data sets based on a type of the user data. The shared AI agent generates personalized recommendations based on the data sets.

### CROSS-REFERENCE TO RELATED APPLICATIONS

This patent application claims priority to Indian Patent Application No. IN 202311079241, filed May 22, 2024, entitled “SYSTEMS AND METHODS FOR CATEGORIZING AND MANAGING PERSONAL DATA STORAGE USING ARTIFICIAL INTELLIGENCE (AI) AGENTS,” and assigned to the assignee hereof. The disclosure of the prior application is considered part of and is incorporated by reference in this patent application.

### TECHNICAL FIELD

Embodiments of the present disclosure generally relate to data management systems and more particularly to systems and methods for categorizing and managing personal data storage using artificial intelligence (AI) agents.

### BACKGROUND

In the era of digital information and ubiquitous data collection, managing personal data has become increasingly complex and critical. The advent of digital technologies, the internet, and the proliferation of connected devices have led to a significant rise in the volume of data generated by individuals on a daily basis. This surge in data creation has given rise to several challenges related to privacy, data organization, and the efficient utilization of this information. One of the primary issues in contemporary data management is the lack of a structured approach to categorizing and managing personal data. Most existing systems and platforms focus on data storage and retrieval but often fall short when it comes to adequately classifying data based on its nature and origin. This deficiency poses significant concerns, especially in an age where data privacy and security are of paramount importance.

Furthermore, the sheer volume of data, both personal and otherwise, that individuals generate and interact with necessitates a more refined system of organization. The absence of such a system has led to data clutter, difficulty in locating specific information when needed, and a general lack of efficiency in accessing and utilizing personal data. Moreover, personalization in various applications has become a pivotal factor for user engagement and satisfaction. Personalized experiences are dependent on the ability to understand an individual's preferences, needs, and historical behaviors. The absence of an effective categorization system makes it challenging to deliver tailored and relevant services.

Consequently, there is a need for improved systems and methods for categorizing and managing personal data storage using artificial intelligence (AI) agents, to address at least the aforementioned issues of the prior arts.

### OBJECTS OF THE INVENTION

A general objective of the present disclosure is to provide a system and a method for categorizing and managing personal data storage using artificial intelligence (ai) agents. The further objectives of present disclosure are discussed below.

Another objective of the present disclosure is to managing interaction of data between a plurality of Artificial Intelligent (AI) agents within a secure cloud-based enclave.

Another objective of the present disclosure is to provide a system for enabling powerful, centralized AI processing and agent interaction without compromising individual user data privacy.

Another objective of the present disclosure is to provide a structured, secure, and auditable method for inter-agent communication, managed by the trusted enclave, solving the problem of insecure and uncontrolled interactions.

Yet another objective of the present disclosure is to deliver highly personalized experiences by using nuanced, AI-generated data categories and inferences within a secure boundary, minimizing the need to share raw sensitive data.

Yet another objective of the present disclosure is to provide a dynamic and granular consent framework.

Still another objective of the present disclosure is to enable relevant and even incentivized advertising/recommendations in a manner that is transparent, user-controlled, and privacy-preserving.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for managing interaction of data between a plurality of Artificial Intelligent (AI) agents within a secure cloud-based enclave. The method comprises initiating, by a single AI agent of the plurality of AI agents, an interaction request with at least one shared AI agent of the plurality of AI agents. The method further comprises triggering, by at least one shared AI agent, a negotiation and authorization process to the single AI agent based on the interaction request. The negotiation and authorization process determines whether the single AI agent is eligible to interact with the shared AI agent. The method further comprises receiving, by at least one shared AI agent, user data from the single AI agent based on the determination that the single AI agent is eligible to interact with the shared AI agent. The method further comprises fetching, by at least one shared AI agent, feedback from prior interactions and historical data related to the user data from a database of the secure cloud-based enclave. The method further comprises categorizing, by at least one shared AI agent, the user data into a plurality of data sets based on a type of the user data, the feedback from prior interactions, and the historical data. The method further comprises generating, by at least one shared AI agent, personalized recommendations based on the plurality of data sets. A logic of the categorization of the user data and the generation of the personalized recommendations are iteratively refined by analyzing logged outcomes and the feedback from prior interactions. The prior interactions and the historical data being securely stored within the database of the secure cloud-based enclave.

In an aspect of the present invention, the method further comprises transmitting, by at least one shared AI agent, the personalized recommendations to the user through a portal and terminating a communication between the single AI agent and at least one shared AI agent.

In an aspect of the present invention, the interaction request is associated with access to a resource within the secure cloud-based enclave.

In an aspect of the present invention, the plurality of data sets comprises at least one of factual immutable data, factual mutable data, historical preferences, current preferences, and inferred data.

In an aspect of the present invention, the plurality if data sets is stored in the database of the secure cloud-based enclave.

In an aspect of the present invention, the secure cloud-based enclave securely retains the user data within the database without directly exposing to an external AI system.

In an aspect of the present invention, at least one shared AI agent filters, selects, and customizes the personalized recommendations based on general user's profile, relevance, user's consent, and preferences.

In another embodiment, the present invention discloses a system for managing interaction of data between a plurality of Artificial Intelligent (AI) agents within a secure cloud-based enclave. The system comprises one or more processors associated with a plurality of AI agents. The system further comprises a memory storing programmed instructions executable by the one or more processors. The one or more processors execute the programmed instructions to initiate, by a single AI agent of the plurality of AI agents, an interaction request with at least one shared AI agent of the plurality of AI agents. The one or more processors are further configured to trigger, by at least one shared AI agent, a negotiation and authorization process to the single AI agent based on the interaction request. The negotiation and authorization process determines whether the single AI agent is eligible to interact with the shared AI agent. The one or more processors are further configured to receive, by at least one shared AI agent, user data from the single AI agent based on the determination that the single AI agent is eligible to interact with the shared AI agent. The one or more processors are further configured to fetch, by at least one shared AI agent, feedback from prior interactions and historical data related to the user data from a database of the secure cloud-based enclave. The one or more processors are further configured to categorize, by at least one shared AI agent, the user data into a plurality of data sets based on a type of the user data, the feedback from prior interactions, and the historical data. The one or more processors are further configured to generate, by at least one shared AI agent, personalized recommendations based on the plurality of data sets. A logic of the categorization of the user data and the generation of the personalized recommendations are iteratively refined by analyzing logged outcomes and the feedback from prior interactions. The prior interactions and the historical data being securely stored within the database of the secure cloud-based enclave.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for categorizing and managing personal data storage using artificial intelligence (AI) agents, in accordance with an embodiment of the present disclosure;

FIG. 2 illustrates an exemplary block diagram representation of a computer implemented system, such as those shown in FIG. 1, capable of categorizing and managing personal data storage using artificial intelligence (AI) agents, in accordance with an embodiment of the present disclosure;

FIG. 3 illustrates an exemplary flow diagram representation of interaction between single agent and shared agents, in accordance with an embodiment of the present disclosure; and

FIG. 4 illustrates a flow chart of a method for managing interaction of data between a plurality of Artificial Intelligent (AI) agents within a secure cloud-based enclave, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for categorizing and managing personal data storage using artificial intelligence (AI) agents.

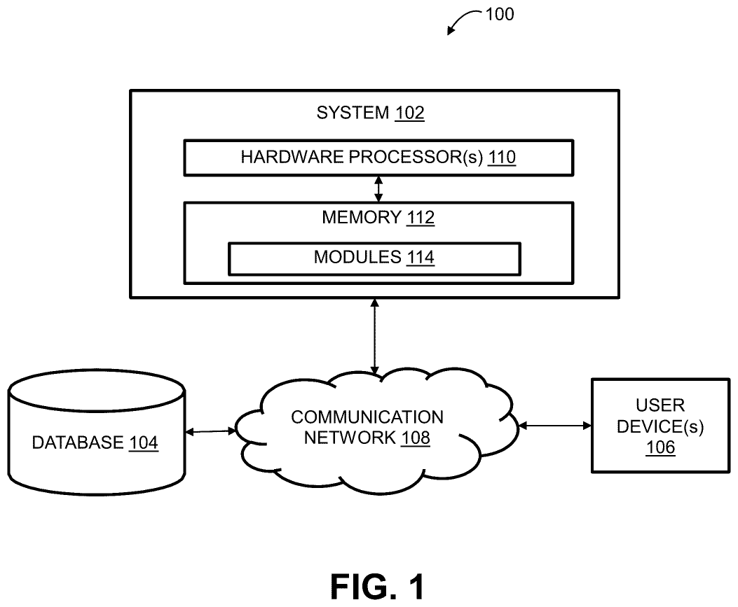

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system for categorizing and managing personal data storage using artificial intelligence (AI) agents, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, single agent data, shared agent data, factual immutable data, factual mutable, historical data, preferences data, inferred data, categorized data, personal data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for categorizing and managing personal data storage using artificial intelligence (AI) agents need. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for categorizing and managing personal data storage using artificial intelligence (AI) agents. Execution of the machine-readable program instructions by the hardware processor 110 may enable the proposed system 102 to categorize and managing personal data storage using artificial intelligence (AI) agents. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may classify data into distinct categories, including factual immutable data, factual mutable data, historical preferences, current preferences, and inferred data.

In an exemplary embodiment, the system 102 may assign factual immutable data as fixed knowledge about an individual. For example, the fixed knowledge includes but is not limited to a date of birth.

In an exemplary embodiment, the system 102 may categorize factual mutable data as transient information, subject to change, and specific to a given moment. The transient information may include but is not limited to an individual's current location.

In an exemplary embodiment, the system 102 may identify historical preferences as information encompassing both factual mutable items and preferences an individual has stated in the past.

In an exemplary embodiment, the system 102 may distinguish current preferences as subjective data expressing an individual's present preferences, including but not limited to food preferences, entertainment preferences, or lifestyle choices.

In an exemplary embodiment, the system 102 may categorize inferred data as data points derived from an individual's actions, behaviors, and historical data, enabling the system to make inferences regarding the individual's preferences and habits. Furthermore, the system 102 is architected such that these inferred data points are not merely static derivations but are dynamically and iteratively refined by at least one shared AI agent 304. This refinement occurs through a learning process that analyses the continuous stream of user interactions, explicit or implicit feedback on recommendations (as received from the single AI agent 302), and observed outcomes of prior recommendations, all of which are logged as historical data within the secure database 104, 204 of the secure cloud-based enclave. This iterative refinement allows the inferred data to become an increasingly accurate and nuanced reflection of the user's evolving preferences, habits, and predictive behaviours over time, enhancing the personalization capabilities of the system 102.

The categorized data may be applicable to both single agents and shared agents, facilitating personalized data management for individual users and multiple users within shared services or environments.

For example, the personal data management, allows individuals to efficiently manage and protect their personal data based on the defined categories. The collaborative applications within shared environments, wherein shared agents, such as household management or collaborative shopping apps, can manage, categorize, and securely share personal data among multiple users.

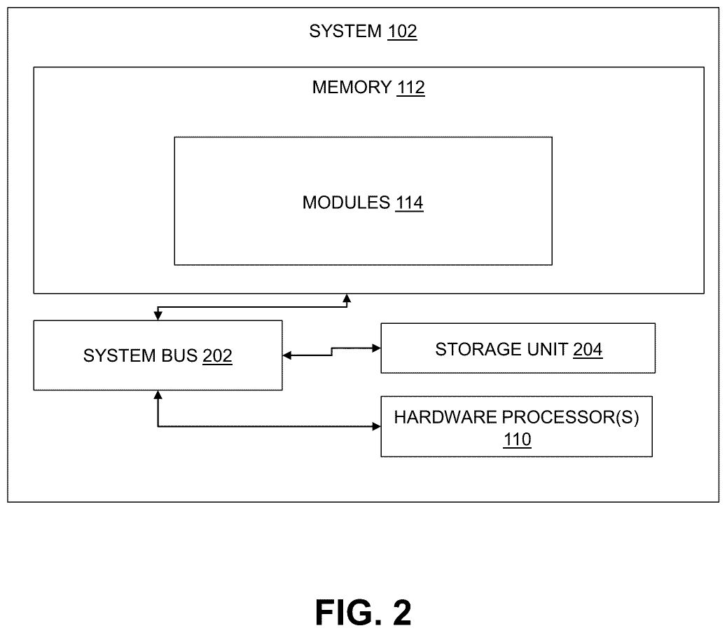

FIG. 2 illustrates an exemplary block diagram representation of a computer implemented system 102, such as those shown in FIG. 1, capable of categorizing and managing personal data storage using artificial intelligence (AI) agents, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, single agent data, shared agent data, factual immutable data, factual mutable, historical data, preferences data, inferred data, categorized data, personal data, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

In an exemplary embodiment, the plurality of modules 114 may classify data into distinct categories, including factual immutable data, factual mutable data, historical preferences, current preferences, and inferred data.

In an exemplary embodiment, the plurality of modules 114 may assign factual immutable data as fixed knowledge about an individual. For example, the fixed knowledge includes but is not limited to a date of birth.

In an exemplary embodiment, the plurality of modules 114 may categorize factual mutable data as transient information, subject to change, and specific to a given moment. The transient information may include but is not limited to an individual's current location.

In an exemplary embodiment, the plurality of modules 114 may identify historical preferences as information encompassing both factual mutable items and preferences an individual has stated in the past.

In an exemplary embodiment, the plurality of modules 114 may distinguish current preferences as subjective data expressing an individual's present preferences, including but not limited to food preferences, entertainment preferences, or lifestyle choices.

In an exemplary embodiment, the plurality of modules 114 may categorize inferred data as data points derived from an individual's actions, behaviors, and historical data, enabling the system to make inferences regarding the individual's preferences and habits. The categorized data may be applicable to both single agents and shared agents, facilitating personalized data management for individual users and multiple users within shared services or environments.

For example, the personal data management, allows individuals to efficiently manage and protect their personal data based on the defined categories. The collaborative applications within shared environments, wherein shared agents, such as household management or collaborative shopping apps, can manage, categorize, and securely share personal data among multiple users.

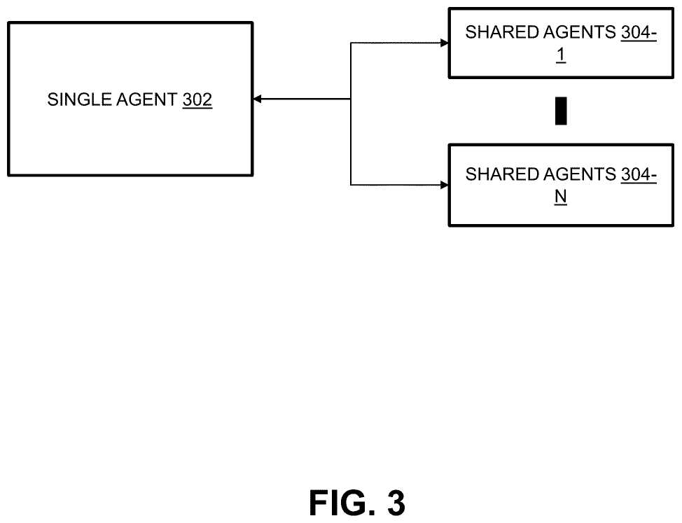

FIG. 3 illustrates an exemplary flow diagram representation of interaction between single agents 302 and shared agents 304, in accordance with an embodiment of the present disclosure. The interaction process between single agents and shared agents is a dynamic and multifaceted concept that can be observed in various domains. Single agents 302, as autonomous entities, operate independently, making decisions and taking actions. The single agents 302 can encompass humans, software programs, robots, or any entity capable of self-directed decision-making. On the other hand, shared agents 304 are entities designed to be accessed or used by multiple individuals or single agents 302. These shared agents can represent software tools, shared resources, or a set of rules facilitating interactions or cooperation among the individual agents.

For single agents 302, factual immutable data may be fixed pieces of knowledge about an individual that do not change over time. For a single agent, this could include information such as an individual's date of birth. The factual mutable may include transient information about the individual, such as the current location (e.g., currently in Singapore). The single agents 302 can track and update this data as needed. The preferences may be historical information that may include both factual mutable items (e.g., past locations) and preferences stated in the past (e.g., past food preferences). Further, the preferences preferred may be current preferences, which are subjective items like an individual's current food preferences (e.g., “I like Japanese food”). Single agents can store and use this information to provide personalized recommendations. Furthermore, the inferred data points may be derived from the user's actions or historical data, such as inferring that someone likes sushi because they frequently visit Japanese food places. Single agents can use algorithms and data analysis to make such inferences.

For shared agents 304, data may be accessible and shared among multiple individuals, such as in a household or shared services such as a shopping app. The same categories of data can apply to shared agents, but the data might be associated with multiple users or profiles. For shared agents 304, the factual immutable may store immutable data for each user profile within the shared service, such as the date of birth for each household member. This can include information such as the current location of each household member within a shared agent system. The preferences may be a storage of historical data and preferences for each user in the shared service, allowing for personalized recommendations and services based on individual or collective preferences. The preferences preferred may be a current preference for each household member that can be stored and used to tailor the shared services to their preferences. Inferred data can also be applied to shared agents 304, such as inferring household-wide preferences based on the collective behaviour of its members.

Referring to FIG. 3, the single agent 302 (e.g., an individual user's AI assistant or a user-operated device) may initiate an interaction by seeking access to the shared agent 304 or a resource within the secure cloud-based enclave. The request may be to store, retrieve, categorize, or manage personal data, or to access a service provided by the shared agent 304. Access is typically requested via Application Programming Interfaces (APIs) designed for interacting with the shared services or resources within the secure cloud-based enclave.

Upon receiving an access request, a negotiation and authorization process may determine if the single agent 302 is eligible to interact with the shared agent 304 or access the requested data/service. This step is critical in a secure cloud-based-enclave to ensure data privacy and prevent unauthorized access. It would involve verifying credentials, permissions, and adherence to predefined policies.

Once access is granted, the single agent 302 may communicate with the shared agent 304 by sending and receiving data, making requests, or performing actions. This communication may occur within the secure confines of the secure cloud-based enclave. The nature of data exchanged involves categorized personal data. The personal data may comprise, but not limited to, factual immutable data, factual mutable data, historical preferences, current preferences, and inferred data. The factual immutable data may comprise fixed knowledge like date of birth. The factual mutable data may comprise transient information like current location. The historical preferences may comprise past preferences and factual mutable items. The current preferences may comprise subjective present preferences like food choices. The inferred data may comprise data derived from actions, behaviors, and historical data.

The single agent 302 may utilize the shared agent to collaborate on tasks, share information, or coordinate actions with other single agents (e.g., multiple users collaborating on a shared document or a family sharing a shopping list managed by a shared household agent).

The single agent 302 and the shared agent 304 may provide feedback to each other to secure cloud-based enhance the quality of interaction or make necessary adjustments. Continuous monitoring within the secure cloud-based enclave helps identify and address issues, ensuring the interaction remains productive, efficient, and secure.

Crucially, such feedback, along with the detailed parameters of the interaction request from the single AI agent 302, the specific user data exchanged, the categorizations applied, the personalized recommendations generated by the shared AI agent 304, and the subsequent actions or responses by the user (via the single AI agent 302), are comprehensively logged as structured historical data within the secure database 104, 204. This logged interaction history, comprising factual inputs, AI-generated inferences and categorizations, and user behavioral responses, forms a rich, temporal dataset. This dataset is subsequently utilized by the shared AI agent 304 to analyze patterns, assess the efficacy of its data categorizations and recommendation logic, and thereby iteratively refine its internal models for improved future interactions and personalization accuracy. The continuous monitoring thus not only ensures operational integrity but also provides critical data points that contribute to the ongoing learning, adaptation, and performance optimization of the shared AI agents 304 in serving the single AI agents 302 and their users.

If conflicting requests or actions arise (e.g., in a shared environment), predefined rules, negotiation protocols, or arbitration processes are employed to resolve these conflicts. Once the interaction is complete, a formal termination process occurs. This involves actions like logging out, releasing shared resources, and ensuring data is handled according to privacy policies.

In an exemplary embodiment, the communication between the single agent 302 and the shared agent 304 may be performed through APIs. However, in alternate embodiments, the communication may be performed using, at least one of Hypertext Transfer Protocol Secure (HTTPS), Transport Layer Security/Secure Sockets Layer (TLS/SSL), secure messaging protocols, authentication protocols, and data encryption at Rest. The HTTPS may ensure that the data exchanged between the user device/single agent and the cloud enclave, as well as between agents within the enclave, is encrypted in transit. The TLS/SSL may be underlying cryptographic protocols that provide secure communication channels for HTTPS. The secure messaging protocols may be an asynchronous messaging that is used between agents or services within the secure cloud-based enclave. The authentication protocols may securely manage authorization and authentication for API access. The data encryption at Rest may not be a communication protocol, data stored within the enclave (e.g., in database 104 or storage unit 204) would be encrypted using strong encryption algorithms to protect it even if physical access to the storage media were compromised. The overall architecture may emphasize end-to-end encryption and strict access controls to maintain the integrity and confidentiality of the data within the secure cloud-based enclave.

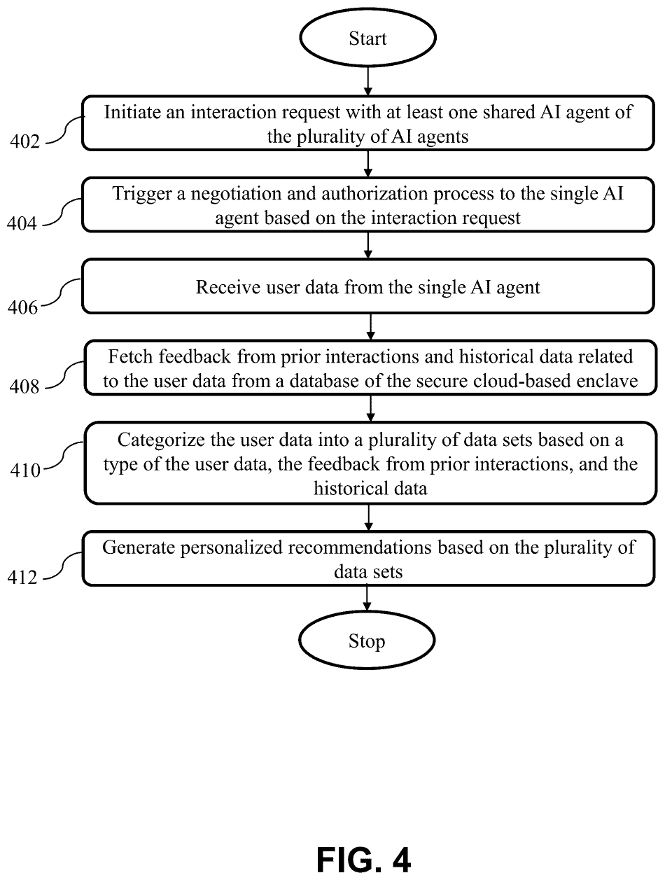

FIG. 4 illustrates a flow chart of a method 400 managing interaction of data between a plurality of Artificial Intelligent (AI) agents within a secure cloud-based enclave, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

At block 402, the single AI agent 302 of the plurality of AI agents may initiate an interaction request with the shared AI agent 304 of the plurality of AI agents. The interaction request is associated with access to a resource within the secure cloud-based enclave. The secure cloud-based enclave securely retains the user data within the database 112 without directly exposing to an external AI system.

At block 404, the shared AI agent 304 may trigger a negotiation and authorization process to the single AI agent 302 based on the interaction request. The negotiation and authorization process may determine whether the single AI agent 302 is eligible to interact with the shared AI agent 304. shared AI agent filters, selects, and customizes the personalized recommendations based on general user's profile, relevance, user's consent, and preferences.

At block 406, the shared AI agent 304 may receive user data from the single AI agent 302 when the single AI agent 302 is eligible to interact with the shared AI agent 304. At block 408, the shared AI agent 304 may fetch feedback from prior interactions and historical data related to the user data from the database 112 of the secure cloud-based enclave.

At block 410, the shared AI agent 304 may categorize the user data into a plurality of data sets based on a type of the user data, the feedback from prior interactions, and the historical data. The plurality of data sets may comprise at least one of, but not limited to, factual immutable data, factual mutable data, historical preferences, current preferences, and inferred data.

At block 412, the shared AI agent 304 may generate personalized recommendations based on the plurality of data sets and the historical data. Further, a logic of the categorization of the user data and the generation of the personalized recommendations are iteratively refined by analyzing logged outcomes and the feedback from prior interactions, and wherein the prior interactions and the historical data being securely stored within the database 204 of the secure cloud-based enclave.

In an exemplary embodiment, the shared AI agent 304 may transmit the personalized recommendations to the user through a portal. Furthermore, a communication between the single AI agent and at least one shared AI agent may be terminated.

In an example, consider a scenario involving a patient (single AI agent 302) interacting with a hospital's AI-powered health management system (shared AI agent 304), all operating within a secure cloud-based enclave. This system is designed to manage sensitive patient data with assurances of privacy. The patient wants to update their current health status and receive personalized wellness recommendations.

In the above scenario, the patient may log into the secure hospital portal using multi-factor authentication. The portal may act as the interface for the single AI agent 302. The patient may initiate a request to update their health metrics (e.g., blood pressure, activity levels recorded by a wearable device) and lifestyle information (e.g., current diet). HTTPS protocol may be used for all communication between the patient's device and the hospital's cloud enclave.

The enclave's authentication service may verify the patient's identity and permissions. It confirms that this specific patient has the right to update their own records and request recommendations. In an implementation, internal secure communication channels (e.g., microservices communicating via RPC with mutual TLS) within the secure cloud-based enclave may handle these authorization checks.

The patient may submit their new data. The single AI agent 302 may transmit the new data to the shared AI agent 304 within the hospital system. The shared AI agent 304 within the hospital system (part of Modules 114 operating on Hardware Processor(s) 110) may categorize the incoming data. The categorization may be performed based on type of data. For example, blood pressure reading may be categorized as factual mutable data, reported adherence to a new diet may be categorized as current preferences/behaviour, activity levels from wearable may be categorized as factual mutable data and potentially used for Inferred Data (e.g., inferring fitness improvement). The data may be stored securely in the enclave's database (database 104). The shared AI agent 304 may process the new data along with existing categorized data (historical preferences, immutable data like diagnosed conditions) to generate personalized wellness recommendations. In an implementation, the data may be exchanged via secure APIs over HTTPS. Sensitive data within the request/response bodies may be encrypted.

The system 102 may provide the patient with wellness recommendations (e.g., dietary adjustments, exercise suggestions) through the portal. Further, the system 102 may continuously monitor for anomalies or patterns in the patient's data that might require attention, potentially flagging it for review by a healthcare professional. In an implementation, HTTPS protocol may be used for feedback to the patient and internal monitoring systems may use secure logging and alerting mechanisms.

Finally, the patient may log out of the portal and the session may be securely terminated. All data remains encrypted at rest within the secure enclave. Access logs are securely maintained for audit purposes. This example demonstrates how the interaction flow, data categorization, and secure communication protocols work together within a cloud-based enclave to manage sensitive personal data while aiming to provide personalized services and maintain user privacy.

In another example, a user has a personal AI concierge (single AI agent 302). The AI concierge operates on user's device but securely syncs and leverages processing capabilities within the secure cloud-based enclave. User's personal data is categorized and managed by the AI concierge within the secure cloud-based enclave, as previously described (factual immutable, factual mutable, historical preferences, current preferences, and inferred data).

The user may subtly show interest in sustainable outdoor gear. He's been researching hiking trails (historical & current preference), his recent purchases include eco-friendly products (historical preference leading to inferred interest in sustainability), and his current location (factual mutable) is near mountainous regions.

The user's AI concierge may utilize the categorized data stored and processed within the secure cloud-based enclave to identify a high probability of user's interest in sustainable hiking gear. Crucially, this detailed personal data (e.g., specific websites visited, exact purchase history, precise location patterns). These personal details are the user within the secure cloud-based enclave. Thus, the personal details are not shared with external advertisers.

Within the secure cloud-based enclave, there exists a “Curated Offers” shared agent (shared agent 304). This agent acts as a privacy-preserving intermediary or a gateway to an advertising marketplace. The external advertisers (e.g., sustainable outdoor gear brands) don't target the user directly. Instead, they provide their campaign parameters, product information, and target audience profiles (e.g., “interested in hiking,” “values sustainability,” “likely to purchase premium gear”) to this Curated Offers Agent. These profiles are generalized and do not contain individual Personally Identifiable Information (PII).

User's AI concierge, having inferred user's interest, can now query the Curated Offers shared agent. In a first method, user's AI concierge sends an anonymized or tokenized request to the Curated Offers agent. The request might say: “seeking offers for user profile matching: [hiking enthusiast, sustainability-focused, premium gear affinity]. User has consented to receive relevant offers.” No direct Pll of user is sent. In a second method, the Curated Offers agent, operating within the secure cloud-based enclave, has access to anonymized signals or aggregated insights derived from multiple single agents (with consent). It can identify a match between an advertiser's campaign profile and user's anonymized profile/inferred interests without directly accessing user's raw data. In an implementation, secure APIs (e.g., RESTful APIs over HTTPS/TLS) are used as communication protocol for this interaction. The payload would be structured (e.g., JSON) and could use temporary secure tokens for the transaction.

The Curated Offers agent returns a set of potentially relevant ad opportunities (e.g., links to product pages, discount codes, rich media ad content) that match the profile. The user's AI concierge then takes these candidate advertisements and uses its deep, private understanding of user's immediate context, current preferences, and even interaction style to select the most relevant and least intrusive advertisement. For example, if user is actively planning a trip (current activity), the AI concierge might prioritize an ad for hiking boots from a brand the user has previously shown affinity for. If the user just browses news, a less direct, perhaps content-based ad (e.g., “discover 5 new sustainable hiking trails and the gear you'll need”) might be chosen.

The user's AI concierge presents the selected advertisement to the user through its interface (e.g., a notification, a suggestion within a relevant app, or even as part of a conversational interaction if the user is chatting with his AI). For example, the user may ask his AI concierge, “What's the weather like in the Blue Mountains this weekend?” The AI may respond with the weather and might add, “Looks like good hiking weather! By the way, based on your interest in sustainable gear, ‘EcoHike Outfitters’ has a new range of all-weather jackets. Would you like to see them?”

User's interaction with the ad (e.g., click, dismissal, purchase) provides feedback to his own AI concierge. This feedback refines the AI's understanding of user's preferences for user's benefit, improving future ad relevance and minimizing unwanted advertisements. Only anonymized and aggregated feedback might be shared with the Curated Offers agent to improve the overall quality of its offerings, if user consents.

In view of the above explanation, the user's detailed personal data remains under their control or within their secure cloud-based enclave, not directly shared with advertisers. Thus, advertising is consent-driven. The final ad selection and presentation are done by the user's own AI agent, which has the deepest and most trusted understanding of the user's context and preferences. The advertisers target generalized profiles, and the user's agent “pulls” or filters relevant ads, rather than advertisers “pushing” ads based on tracking individuals across the web. The advertisements are more likely to be seen as helpful recommendations rather than intrusive interruptions because they are delivered by the user's trusted AI concierge in a contextually appropriate manner. The secure cloud-based enclave facilitates these interactions, ensuring that data processing and matchmaking adhere to strict privacy and security protocols. The system allows for conversational commerce and more integrated, less jarring ad experiences. Further, the system can easily incorporate incentivized ads where users might receive discounts or rewards for engaging with specific offers, with the transaction facilitated securely through their AI agent.

The interaction process between the single agents 302 and the shared agents 304 may typically follow a structured pattern. It often begins with a request and access phase, where single agents initiate interaction by seeking access to the shared agent. This access request may involve using application programming interface (APIs) to interact with shared software services or requesting permission to utilize shared physical resources. Depending on the context, a negotiation and authorization process may be required to determine whether the single agent is eligible to interact with the shared agent.

Once access is granted, the interaction proceeds with data exchange and communication. Single agents 302 can communicate with the shared agent 304, either by sending and receiving data, making requests, or performing various actions. This phase is central to achieving the objectives of the interaction, which can vary widely based on the domain and purpose. The nature of the interaction extends to cooperation and collaboration. Single agents 302 often utilize shared agents to work together on specific tasks, share information, or coordinate actions. This collaborative aspect is prominent in settings such as multiple users collaborating on a shared document editing tool through a shared agent 304.

As the interaction progresses, feedback and monitoring mechanisms come into play. Single agents 302 and shared agents 304 may provide feedback to each other to enhance the quality of interaction or make necessary adjustments. Monitoring can help identify and address issues as they arise, ensuring the interaction remains productive and efficient.

In some cases, conflict resolution mechanisms are required. Conflicting requests or actions may arise during the interaction, and predefined rules, negotiation, or arbitration processes may be necessary to resolve these conflicts amicably.

Finally, as the interaction concludes, there is a need for termination and clean up. Single agents 302 and shared agents 304 must handle the conclusion of the interaction, which may involve actions such as logging out, releasing shared resources, or ending the interaction gracefully. The efficiency and effectiveness of this phase are crucial for ensuring a seamless and positive interaction experience. The specific details of the interaction process can vary significantly based on the specific domain, the types of agents involved, and the technology being utilized. Whether observed in human-computer interactions, multi-agent systems in artificial intelligence, or shared resource management in economic contexts, the interaction process aims to facilitate cooperation, achieve goals, and ensure a harmonious and productive interaction between single agents 302 and shared agents 304. In an implementation, the behaviours can be also body language, voice, tones, style, dressing sense, 3d entities and mappings.

In embodiments where the single AI agent 302 or user device 106 is capable of capturing or processing such richer behavioral signals (subject to user consent and privacy controls), these signals can be securely transmitted as part of the user data to the shared AI agent 304 within the enclave. The shared AI agent 304 can then incorporate processed representations of these behavioral signals into its data categorization and inference generation processes. For example, a processed representation of a hesitant voice tone detected during a user's interaction (via the single AI agent 302) in response to a specific recommendation might be logged. This logged behavioral cue, when correlated with other interaction data, can be used by the shared AI agent 304 during its iterative learning process to refine its confidence scores for certain inferred preferences or to adjust its recommendation strategy for that user. All such processing of behavioral data for enhanced inference generation and model refinement occurs strictly within the secure cloud-based enclave, ensuring robust privacy safeguards while contributing to a more intuitive and responsive system 102.

In an example, consider, personalized travel planning with data categorization. For example, the single agent's shared agent may be a travel planning application. User 1, a travel enthusiast, frequently uses a travel planning application that employs data categorization. This application allows User 1 to input and manage their personal data while providing personalized travel recommendations and experiences. Step 1: data categorization and setup. User 1 logs into the travel planning application as a Single Agent. They set up their data categorization preferences: Factual Immutable: User 1 provides their date of birth, marking it as immutable. Factual Mutable: User 1 updates their current location to “Singapore” since they are currently visiting the city. Preferences (Historical): User 1 enters historical travel preferences, including past destinations and favorite activities. Preferences Preferred: User 1 specifies their current preferences, expressing a preference for Japanese food, as they have been enjoying it lately. Inferred: The application tracks User 1's recent visits to Japanese restaurants and infers a preference for sushi.

Step 2: personalized travel recommendations. The travel planning application leverages the categorized data to offer personalized travel recommendations to User 1: Based on User 1's historical preferences, the app suggests destinations and activities that align with their past travel experiences and interests. The application also recommends Japanese restaurants and sushi bars in Singapore, taking into account User 1's preference for Japanese food. Step 3: enhanced data privacy and sharing control. User 1 values their privacy and wants to ensure their data is used responsibly. They use the privacy controls within the app: User 1 decides to share their historical preferences with the travel planning app to receive more accurate recommendations. However, User 1 keeps their inferred preference for sushi private, limiting its use within the app.

Step 4: shared agent integration, while planning a vacation with friends (User 2 and User 3), User 1 shares their travel itinerary within the travel planning app. The app facilitates shared planning and seamless coordination: User 1's shared travel plans and preferences are integrated with those of User 2 and User 3, making it easier to collaboratively plan the trip.

Step 5: seamless travel planning and booking. User 1, User 2, and User 3 use the travel planning app to explore destinations and activities. They receive personalized suggestions, and their shared preferences for travel are taken into account. The application provides recommendations that align with the group's shared preferences and historical travel experiences, enhancing the travel planning process.

In another example, consider a scenario of an efficient household shopping with data categorization. User 1 may be a shared agent (household member) user 2 may be a shared agent (household member) shared agent: household shopping app. User 1 and User 2 share a household and frequently use a household shopping application that incorporates data categorization. This app streamlines their shopping experience while maintaining privacy and personalization. Step 1: collaborative data categorization. User 1 and User 2, acting as shared agents, log into the household shopping app and categorize their shared household data. The shared household preferences, both users categorize their shared preference for organic produce when shopping. Routines: user 1 and user 2 categorize their shared routines, including daily meal planning and grocery shopping schedules. Step 2: efficient shopping list generation, the household shopping app utilizes the categorized data to create an optimized shopping list: The app generates a shopping list that includes organic produce and other items needed for their shared routines, such as breakfast and dinner ingredients.

Step 3: data privacy and shared preferences, User 1 and User 2 want to ensure their data privacy and control. They use of the privacy settings within the app: they choose to share their shared household preferences and routines with the app, as it streamlines their shopping experience. However, they keep their individual preferences and personal data private, ensuring that their own preferences are not shared with the app or other users.

Step 4: streamlined shopping experience, User 1 and User 2 access the shopping list within the app, simplifying their grocery shopping: The app provides an organized shopping list that takes into account their shared preferences for organic produce and their daily routines. Step 5: real-time updates and notifications, while shopping, User 1 and User 2 can make real-time updates to the shopping list within the app: they add or remove items as needed, and the app updates the list accordingly. The app sends notifications to both users, ensuring they stay in sync while shopping.

The present invention provides a system and a method for managing interaction of data between a plurality of Artificial Intelligent (AI) agents within a secure cloud-based enclave. The system may enable powerful, centralized AI processing and agent interaction without compromising individual user data privacy, by creating a trusted and controlled environment to overcome risk of keeping user data localized (limiting AI capabilities) or centralize. Furthermore, the system addresses the technical challenge of creating a demonstrably secure and private cloud environment specifically designed for AI operations on personal data, thereby fostering user trust.

The system provides a structured, secure, and auditable method for inter-agent communication, managed by the trusted enclave, solving the problem of insecure and uncontrolled interactions. Further, the system solves the technical problem of enforcing consistent access control and permissions across a distributed system of AI agents by centralizing key aspects of the interaction (like authN/authZ) within the secure cloud-based enclave.

To uphold user privacy and control, the system 102 implements a dynamic and granular consent management framework, typically orchestrated by modules 114 within the shared AI agent 304 in conjunction with the single AI agent 302. This framework enables users, through their single AI agent 302, to define, review, and modify permissions for the access, use, and sharing of their personal data by shared AI agents 304. Consent can be specified at a granular level, for instance, allowing different access rights for distinct data categories (e.g., permitting use of ‘historical preferences’ for travel recommendations but restricting ‘current location’ data for unrelated services), for defined purposes (e.g., consenting to ‘inferred data’ for health advice but not for third-party advertising unless explicitly opted-in), or for specific durations. The secure cloud-based enclave 102 is configured to enforce these user-defined consent parameters rigorously across all agent interactions and data processing activities. All consent directives, modifications, and data access events governed by these consents are securely logged within the database 104, 204, providing an auditable trail and reinforcing the transparent and user-controlled nature of data management within the system.

The system solves the technical challenge of delivering highly personalized experiences by using nuanced, AI-generated data categories and inferences within a secure boundary, minimizing the need to share raw sensitive data. The AI-driven categorization creates a structured, actionable representation of personal data, solving the problem of data clutter and enabling more efficient and intelligent use of this information for the user's benefit.

The system solves the technical problem of enabling relevant and even incentivized advertising/recommendations in a manner that is transparent, user-controlled, and privacy-preserving by shifting the intelligence and data control closer to the user (via their single agent and the secure cloud-based enclave). Further, the system gives the user's AI agent a more active role in mediating how their inferred interests are used for services like advertising, solving the problem of a lack of user agency.

The system provides a dynamic and granular consent framework, solving the technical problem of enabling flexible yet robust control over personal data usage in a complex AI agent ecosystem. The system creates a uniquely evolving and increasingly accurate service without requiring repeated, explicit data dumps or compromising privacy through external model training. The secure cloud-based enclave ensures this learning loop remains secure. This iterative learning and service evolution are achieved by the shared AI agents 304 within the enclave analyzing the securely logged historical data, which includes categorized user data, details of interactions with single AI agents 302, outcomes of personalized recommendations, and user feedback. By applying machine learning techniques to this rich internal dataset, the shared AI agents 304 continuously refine their data categorization logic, the accuracy of their inferred data, and the effectiveness of their recommendation models, leading to a progressively enhanced and more personalized user experience over time, all performed while upholding stringent data privacy within the enclave's secure processing environment. Furthermore, the system creates a distributed trust model where the user's personal agent is a key technical element in safeguarding their interests. In addition, the system provides valuable aggregated insights while guaranteeing individual de-identification and privacy.

The system further solves the technical challenge of managing trust and security in a distributed yet controlled AI environment, preventing rogue agents or data leakage through third-party shared agents. Furthermore, the system creates a holistic privacy-preserving system for AI-driven services.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for categorizing and managing personal data storage using artificial intelligence (AI) agents. Data categorization, which encompasses the classification of data into specific categories such as factual immutable, factual mutable, preferences (historical), preferences preferred, and inferred, offers a multitude of benefits that enhance user experiences and data management. By categorizing data, users receive recommendations and services tailored to their unique preferences, historical behavior, and inferred preferences. This not only improves user satisfaction but also ensures that the content and services delivered are highly relevant. Moreover, data categorization streamlines data organization and retrieval, making it easier for individuals and shared agents to manage their personal information efficiently. This organized approach optimizes the user's digital experience and enables them to locate specific data quickly. Simultaneously, it empowers users with enhanced privacy control. Categorized data gives individuals the ability to choose what data they want to share and with whom. This control over data privacy is paramount in today's data-driven world. Categorized data also serves as a valuable source of insights. Single agents and shared agents can draw meaningful conclusions from this data, gaining a deeper understanding of user preferences, historical behaviors, and inferred tendencies. With this knowledge, businesses and service providers can make informed decisions, deliver more targeted marketing efforts, and enhance the quality of their products and services. Furthermore, users can collaborate more efficiently in shared environments. For example, household shopping apps can benefit from categorized data by providing shared preferences and routines while preserving individual privacy, leading to streamlined and collaborative household tasks. In addition to enhancing the user experience, data categorization contributes to time and resource efficiency. It simplifies tasks like travel planning and shopping by generating optimized recommendations, schedules, and lists.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

1. A method for managing interaction of data between a plurality of Artificial Intelligent (AI) agents within a secure cloud-based enclave, comprising:
initiating, by a single AI agent of the plurality of AI agents, an interaction request with at least one shared AI agent of the plurality of AI agents;
triggering, by at least one shared AI agent, a negotiation and authorization process to the single AI agent based on the interaction request, wherein the negotiation and authorization process determines whether the single AI agent is eligible to interact with the shared AI agent;
based on the determination that the single AI agent is eligible to interact with the shared AI agent, receiving, by at least one shared AI agent, user data from the single AI agent;
fetching, by at least one shared AI agent, feedback from prior interactions and historical data related to the user data from a database of the secure cloud-based enclave;
categorizing, by at least one shared AI agent, the user data into a plurality of data sets based on a type of the user data, the feedback from prior interactions, and the historical data; and
generating, by at least one shared AI agent, personalized recommendations based on the plurality of data sets, wherein a logic of the categorization of the user data and the generation of the personalized recommendations are iteratively refined by analyzing logged outcomes and the feedback from prior interactions, and wherein the prior interactions and the historical data being securely stored within the database of the secure cloud-based enclave.

2. The method according to claim 1, further comprising:
transmitting, by at least one shared AI agent, the personalized recommendations to the user through a portal; and
terminating a communication between the single AI agent and at least one shared AI agent.

3. The method according to claim 1, wherein the interaction request is associated with access to a resource within the secure cloud-based enclave.

4. The method according to claim 1, wherein the plurality of data sets comprises at least one of factual immutable data, factual mutable data, historical preferences, current preferences, and inferred data.

5. The method according to claim 1, wherein the plurality if data sets is stored in the database of the secure cloud-based enclave.

6. The method according to claim 1, wherein the secure cloud-based enclave securely retains the user data within the database without directly exposing to an external AI system.

7. The method according to claim 1, wherein at least one shared AI agent filters, selects, and customizes the personalized recommendations based on general user's profile, relevance, user's consent, and preferences.

8. A system for managing interaction of data between a plurality of Artificial Intelligent (AI) agents within a secure cloud-based enclave, comprising:
one or more processors associated with a plurality of AI agents; and
a memory storing programmed instructions executable by the one or more processors, wherein the one or more processors execute the programmed instructions to:
initiate, by a single AI agent of the plurality of AI agents, an interaction request with at least one shared AI agent of the plurality of AI agents;
trigger, by at least one shared AI agent, a negotiation and authorization process to the single AI agent based on the interaction request, wherein the negotiation and authorization process determines whether the single AI agent is eligible to interact with the shared AI agent;
based on the determination that the single AI agent is eligible to interact with the shared AI agent, receive, by at least one shared AI agent, user data from the single AI agent;
fetch, by at least one shared AI agent, feedback from prior interactions and historical data related to the user data from a database of the secure cloud-based enclave;
categorize, by at least one shared AI agent, the user data into a plurality of data sets based on a type of the user data, the feedback from prior interactions, and the historical data; and
generate, by at least one shared AI agent, personalized recommendations based on the plurality of data sets, wherein a logic of the categorization of the user data and the generation of the personalized recommendations are iteratively refined by analyzing logged outcomes and the feedback from prior interactions, and wherein the prior interactions and the historical data being securely stored within the database of the secure cloud-based enclave.

9. The system according to claim 8, wherein the one or more processors are further configured to:
transmit, by at least one shared AI agent, the personalized recommendations to the user through a portal; and
terminate a communication between the single AI agent and at least one shared AI agent.

10. The system according to claim 8, wherein the interaction request is associated with access to a resource within the secure cloud-based enclave.

11. The system according to claim 8, wherein the plurality of data sets comprises at least one of factual immutable data, factual mutable data, historical preferences, current preferences, and inferred data.

12. The system according to claim 8, wherein the plurality if data sets is stored in the database of the secure cloud-based enclave.

13. The system according to claim 8, wherein the secure cloud-based enclave securely retains the user data within the database without directly exposing to an external AI system.

14. The system according to claim 8, wherein at least one shared AI agent filters, selects, and customizes the personalized recommendations based on general user's profile, relevance, user's consent, and preferences.

15. A non-transitory machine-readable medium including data, which when used by a system for managing interaction of data between a plurality of Artificial Intelligent (AI) agents within a secure cloud-based enclave, causes the system to perform instructions that cause the system to perform operations comprising:
initiating, by a single AI agent of the plurality of AI agents, an interaction request with at least one shared AI agent of the plurality of AI agents;
triggering, by at least one shared AI agent, a negotiation and authorization process to the single AI agent based on the interaction request, wherein the negotiation and authorization process determines whether the single AI agent is eligible to interact with the shared AI agent;
based on the determination that the single AI agent is eligible to interact with the shared AI agent, receiving, by at least one shared AI agent, user data from the single AI agent;
fetching, by at least one shared AI agent, feedback from prior interactions and historical data related to the user data from a database of the secure cloud-based enclave;
categorizing, by at least one shared AI agent, the user data into a plurality of data sets based on a type of the user data, the feedback from prior interactions, and the historical data; and
generating, by at least one shared AI agent, personalized recommendations based on the plurality of data sets, wherein a logic of the categorization of the user data and the generation of the personalized recommendations are iteratively refined by analyzing logged outcomes and the feedback from prior interactions, and wherein the prior interactions and the historical data being securely stored within the database of the secure cloud-based enclave.
